(19) United States
(12) Patent Application Publication
(10) Pub. No.: US 2011/0107219 A1
(43) Pub. Date: May 5, 2011

(54) SERVICE PROVIDING APPARATUS AND METHOD FOR RECOMMENDING SERVICE THEREOF

(75) Inventors: Jin-young JEON, Seoul (KR); Soo-hong Park, Yongin-si (KR); Jin-guk Jeong, Yongin-si (KR); Hee-jeong Choo, Anyang-si (KR); Se-jun Park, Yongin-si (KR); Ji-young Kwahk, Seongnam-si (KR); Hee-jeong Bae, Suwon-si (KR); Jong-chan Park, Uiwang-si (KR); Bo-kyung Shim, Seoul (KR); Jin-ho Yim, Suwon-si (KR)

(73) Assignee: Samsung Electronics Co., Ltd., Suwon-si (KR)

(21) Appl. No.: 12/940,694

(22) Filed: Nov. 5, 2010

(30) Foreign Application Priority Data
Nov. 5, 2009 (KR) 10-2009-0106522
Jan. 28, 2010 (KR) 10-2010-0007890
Oct. 18, 2010 (KR) 10-2010-0101252

(51) Int. Cl. G06F 3/00

(52) U.S. Cl. 715/716

(57) ABSTRACT

A service providing apparatus and method are provided. The service providing apparatus includes a receiving unit that receives content metadata and a controller that determines a related service based on the received content metadata and a user metadata, and provides a determined related service.

### PRIORITY

This application claims priority under 35 U.S.C. §119(a) to Korean Patent Application Nos. 2009-0106522, 2010-0007890, and 2010-0101252, which were filed in the Korean Intellectual Property Office on Nov. 5, 2009, Jan. 28, 2010, and Oct. 18, 2010, respectively, the disclosures of which are incorporated herein by reference.

### BACKGROUND OF THE INVENTION

1. Field of the Invention

The present invention relates generally to a service providing apparatus and a method for recommending service thereof, and more particularly, to a service providing apparatus using user metadata and a method for recommending service thereof.

2. Description of the Related Art

Various content is provided to fixed and mobile apparatuses from a content providing apparatus, e.g., a server or a base station. However, in order to search the content and related content in an apparatus receiving the various content from the content providing apparatus, a user goes through numerous trials and errors.

Recently, a method using metadata for searching content intuitively and swiftly has been introduced to resolve such inconvenience. However, as information regarding content provided through metadata is still very limited, a user performs an additional search for detailed content provided through metadata.

### SUMMARY OF THE INVENTION

The present invention has been designed to solve at least the above-mentioned problems occurring in the prior art.

Accordingly, an aspect of the present invention is to provide a display apparatus, a user terminal, and methods thereof, with which a user searches information regarding a desired object more conveniently and precisely, by combining information regarding the location of a user terminal with information regarding the location of an object selected by the user.

In accordance with an aspect of the present invention, a method for recommending a service in a service providing apparatus is provided. The method includes receiving content metadata, determining a related service based on the received content metadata and at least one user metadata, and providing the determined related service.

In accordance with an aspect of the present invention, a service providing apparatus is provided. The service providing apparatus includes a receiving unit that receives content metadata, and a controller that determines a related service based on the received content metadata and at least one user metadata and provides the determined related service.

### BRIEF DESCRIPTION OF THE DRAWINGS

The above and/or other aspects, features, and advantages of certain embodiments of the present invention will be more apparent from the following detailed description taken in conjunction with reference to the accompanying drawings, in which:

FIG. 1 illustrates a service providing system according to an embodiment of the present invention;

FIG. 2 illustrates a system using movie-related content provided by a kiosk;

FIGS. 3A and 3B illustrate a movie calendar according to an embodiment of the present invention;

FIG. 4 illustrates a system using movie-related content provided by a content reproducing apparatus;

FIG. 5 illustrates a system using music-related content provided by an MP3 player;

FIG. 6 illustrates a service providing system according to another embodiment of the present invention;

FIG. 7 is a flowchart illustrating a content providing method according to an embodiment of the present invention;

FIG. 8 is a flowchart illustrating a content providing method according to another embodiment of the present invention;

FIGS. 9 to 11 are flowcharts illustrating content providing methods according to other embodiments of the present invention;

FIG. 12 illustrates a service providing apparatus according to another embodiment of the present invention;

FIG. 13 illustrates a display of a display unit according to an embodiment of the present invention; and

FIG. 14 is a flowchart illustrating a method for recommending a service according to an embodiment of the present invention.

### DETAILED DESCRIPTION OF EMBODIMENTS OF THE INVENTION

Various embodiments of the present invention are described in detail below with reference to the accompanying drawings. In the following description, like drawing reference numerals are used for the like elements, even in different drawings. The matters defined in the description, such as detailed construction and elements, are provided to assist in a comprehensive understanding of exemplary embodiments. However, the described embodiments can be practiced without those specifically defined matters. Also, well-known functions or constructions are not described in detail since they would obscure the application with unnecessary detail.

FIG. illustrates a service providing system according to an embodiment of the present invention.

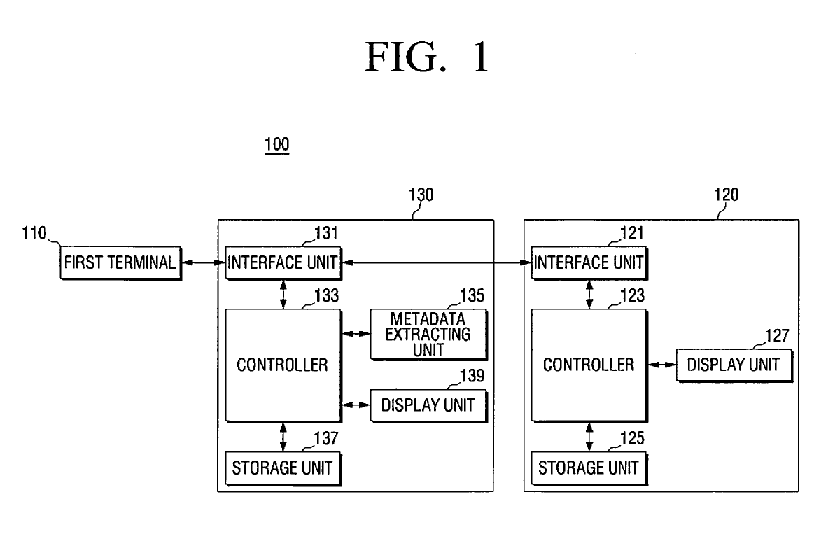

Referring to FIG. 1, a service providing system 100 includes a first terminal 110, a second terminal 120, and a third terminal 130. The first terminal 110 provides content. For example, the first terminal 110 may be a kiosk that is installed at location, such as a movie theater, a train station, or a bus terminal, to provide various content including purchasing, issuing, and registering a ticket. Alternatively, the first terminal 110 may be content providing device such as a Portable Media Player (PMP), an MP3 player, a DVD reproducing apparatus, a Personal Digital Assistant (PDA), or other mobile device. Herein, the content may include text, an image, a video, audio, or a combination of any of the above.

The third terminal 130 extracts content metadata from content provided by the first terminal 100, and transmits the extracted content metadata to the second terminal 120. For example, the third terminal 130 may be a mobile apparatus such as a cellular phone. However, the third terminal 130 is not limited thereto and may be any apparatus that is connectable to the first terminal 110.

The third terminal 130 includes an interface unit 131, a controller 133, a metadata extracting unit 135, a storage unit 137, and a display unit 139. The interface unit 131 receives content from the first terminal 110 and transmits content data extracted from content to the second terminal 120. The interface unit 131 transmits and receives data to and from the first terminal 110 and the second terminal 120 through a wired connection or using various known wireless communication methods.

The controller 133 controls the overall controlling operation of the third terminal 130. Specifically, the controller 133 controls the metadata extracting unit 135 to extract content metadata from received content. The controller 133 controls the metadata extracting unit 135 to extract content metadata from received content after the third terminal 130 is connected to the first terminal 110, and a user command to extract content metadata is input to the third terminal 130.

The metadata extracting unit 135 extracts content metadata from content provided by the first terminal 110. Specifically, the metadata extracting unit 135 extracts content metadata by clipping content metadata from the content provided by the first terminal 110. Herein, the metadata generally refers to data about data, which includes various information or properties regarding sub data, and may be divided into content metadata and user metadata, which includes individual characteristics of each user.

For example, content metadata about a movie may provide movie information such as the movie title, show times, actors/actresses, a type (or genre), a director, a producer, etc. Similarly, content metadata about music may provide music information such as a song title, a singer, a featured singer, a music company that the singer belongs to, an award-winning record, etc. In addition, content metadata regarding departure and arrival times of a train or a bus in a train station or a bus terminal may provide information such as a departure time, an arrival time, an indication of empty seats, a transit point, advance purchase information, etc.

The storage unit 137 stores the extracted metadata. The storage unit 137 may store content metadata in the form of a file, along with the associated content. Various data may be stored in the storage unit 137 in addition to content and corresponding content metadata.

The display unit 139 displays whether content metadata has been extracted or not.

The second terminal 120 searches related content by combining transmitted content metadata with a user profile. The second terminal 120 includes an interface unit 121, a controller 123, a storage unit 125, and a display unit 127. For example, the second terminal 120 may be a laptop computer or a desktop computer.

The interface unit 121 receives content metadata transmitted from the third terminal 130 and the controller 123 searches related content by combining received content metadata with a user profile.

For example, user metadata includes a user preference and a user history. User metadata, unlike content metadata extracted from content of the first terminal 110, is input from the second terminal 120 or pre-stored in the second terminal 120. Alternatively, user metadata may be input from the third terminal 130 or pre-stored in the third terminal 130. When in the third terminal 130, the user metadata is transmitted to the second terminal 120 with content metadata.

The storage unit 125 stores content metadata received from the third terminal 130 and stores user metadata.

The display unit 127 displays a User Interface (UI) for designating user metadata. In addition, the display unit 127 displays a generated movie calendar and a web page that is linked to related content.

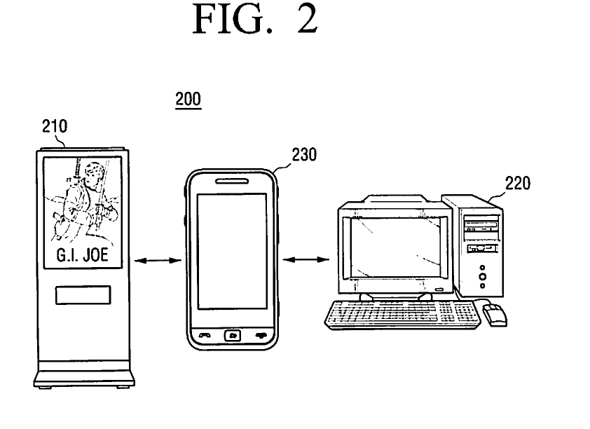

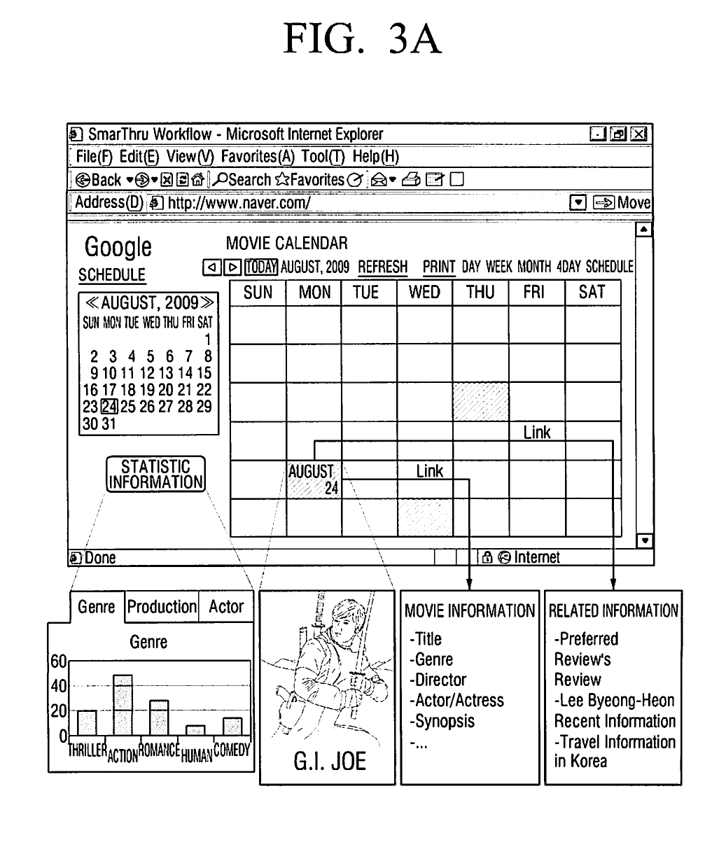

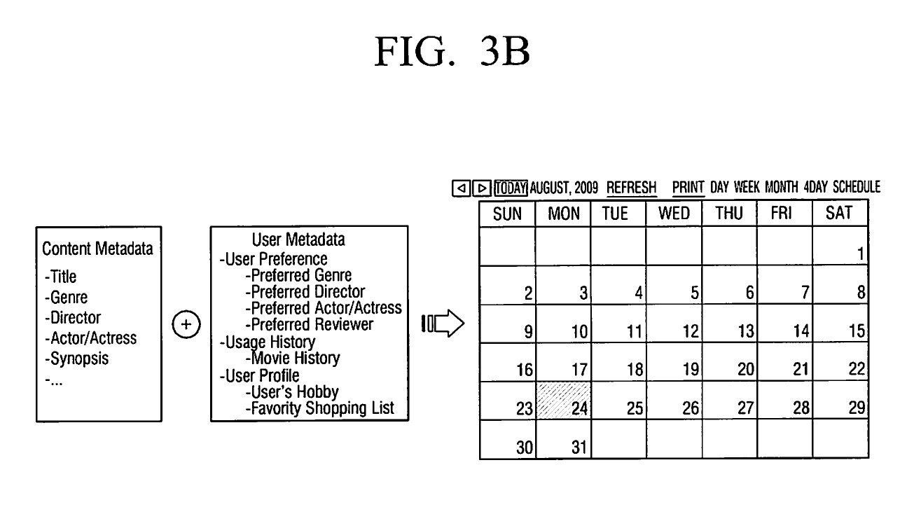

FIG. 2 illustrates a service providing system using movie-related content provided by a kiosk, and FIGS. 3A and 3B illustrate a generated movie calendar.

Referring to FIG. 2, a service providing system 200 includes a first terminal 210, a second terminal 220, and a third terminal 230. Specifically, the first terminal 210 is a kiosk, the second terminal 220 is a Personal Computer (PC), and the third terminal 230 is a cellular phone. Hereinafter, the first terminal 210, the second terminal 220, and the third terminal 230 will be referred to as the kiosk 210, the PC 220, and the cellular phone 230, respectively, for convenience of explanation. However, the first terminal 210, the second terminal 220, and the third terminal 230 are not limited to these specific devices.

Additionally, the first terminal 210, the second terminal 220, and the third terminal 230 include the same components as illustrated in the first terminal 110, the second terminal 120, and the third terminal 130 (for example, an interface unit 131, a controller 133, a metadata extracting unit 135, a storage unit 137, a display unit 139, etc.). Accordingly, when describing the first terminal 210, the second terminal 220, and the third terminal 230, the components thereof (although not illustrated in FIG. 2) will be referred to using the same numerical identifiers illustrated in FIG. 1.

A user connects the cellular phone 230 to the kiosk 210 to obtain content regarding a movie in a theater. The cellular phone 230 may be wirelessly connected to the kiosk 210, or the cellular phone 230 may be connected to the kiosk 220 through a wired connection.

The interface unit 131 of the cellular phone 230 receives content including content metadata from the kiosk 210. The metadata extracting unit 135 of the cellular phone 230 extracts the content metadata from content received from the interface unit 131 by clipping the content metadata under the control of the controller 133. The storage unit 137 of the cellular phone 230 stores the content metadata, e.g., the movie title, show times, actors/actresses, genre, director, and/or producer.

The controller 123 of the PC 220 generates a movie calendar using the content metadata transmitted to the PC 220 and user metadata, and displays the generated movie calendar through the display unit 127.

Thereafter, a user may use a service provided through the movie calendar to easily identify, e.g., movie viewing status, history, and related content that are optimally generated for the specific user.

Referring to the movie calendar illustrated in FIGS. 3A and 3B, a user watches “G. I. Joe” on Aug. 24, 2009 in a theater. Accordingly, a movie calendar is generated including content metadata (i.e., movie information), such as the movie viewing date, the movie title, the show time, and the actors/actresses, in an area for Aug. 24, 2009. Additionally, related content (i.e., related information about the movie) may be generated in the PC 220 under the control of the controller 123. The generated movie calendar may be displayed by the PC 220. The related content may then be searched using content metadata and user metadata.

In accordance with another embodiment, a movie calendar may be displayed in the form of a movie poster to inform a user that the movie calendar for a corresponding date is generated. If a user selects (e.g., clicks) the movie poster, the user may see movie information from the content metadata and related information from the related content.

Additionally, a detailed description regarding a movie may be directly input by a user in an area for Aug. 24, 2009 of the movie calendar. As illustrated in FIG. 3A, the movie calendar may be embodied using a web browser or other applications.

The display unit 127 displays movie information (content metadata) and related information (related content) under the control of the controller 123. Specifically, various embodiments may be presented depending on the type of user metadata.

For example, if the user metadata is “user preference”, a UI for directly inputting a user preference, may be displayed in the display unit 127 under the control of the controller 123.

For example, if “director Steve Sommers” is input as the user preference through a UI, the controller 123 automatically searches content regarding a previous movie produced by “director Steve Sommers” or articles regarding “director Steve Sommers,” and provides corresponding link information. A user command regarding which content are to be searched, from among the director's previous movies or articles regarding the director, may be input separately.

Alternatively, statistical information may be pre-stored in the storage unit 125 of the PC 220 or the storage unit 137 of the cellular phone 230. For example, if movies produced by Steve Sommers are watched mostly using the PC 220, statistical information that the movies produced by Steve Sommers are most frequently watched is stored in the PC 220.

When a movie calendar regarding the movie “G.I. Joe” is generated, recent articles regarding Steve Sommers (i.e., related content) may be searched using content metadata regarding the movie director Steve Sommers and information about movies most frequently watch among movies produced by Steve Sommers compared to other directors (i.e., user metadata). Link information may be provided under the control of the controller 123.

If a user's website connection information is stored in the PC 220 statistically, and if the website connection information includes more items regarding traveling than any other item, information that the user's hobby is travelling (e.g., user metadata indicating user preference) may be pre-stored. In this case, the user metadata may be stored in the cellular phone 130 or the PC 220.

When the movie calendar regarding “G.I. Joe” is generated under the control of the controller 123, if the filming location of “G.I. Joe” (i.e., content metadata) is Korea, travel information in Korea (i.e., related content) may be searched and corresponding link information may be provided.

As another example, if user metadata is “a user profile”, the controller 123 may automatically search related content using the user profile. For example, the controller 123 may infer that a man in his twenties likes action movies using a pre-stored user profile that a user is a man in his twenties.

When the movie calendar regarding “G.I. Joe” is generated under the control of the controller 123, the display unit 127 may automatically search action movies where actor “Lee, Byeong-Heon” starred previously (i.e., related content) by using actor Lee, Byeong-Heon (i.e., content metadata) and action movies inferred from the user profile (i.e., user metadata), and provide link information. In addition, a website (i.e., related content) for purchasing DVDs for movies in which Lee Byeong-Heon starred previously (i.e., related contents) may be searched and corresponding link information may be provided. That is, the display unit 127 may display a web page providing product information regarding the related content. In this case, providing product information regarding related contents may be regard as providing a service.

In addition, the controller 123 may receive information of “a man in his twenties” directly from a user through a UI as a user profile and search related content automatically.

As another example, the user metadata may be “usage history”. In this case, the controller 123 may automatically search related content using a pre-stored usage history.

More specifically, when the movie calendar regarding “G.I. Joe” is generated under the control of the controller 123, melodramatic movies where actor Lee, Byeong-Heon starred (i.e., related content) may be searched using user history (i.e., user metadata), which indicates that a user prefers melodramatic movies to action movies, and link information may be provided.

Referring to FIG. 3B, a movie calendar is generated by combining content metadata extracted or received from the first terminal 110 with user metadata. Accordingly, the second terminal 120 provides a service, such as movie viewing status, history, and related contents through the movie calendar.

Conventionally, if a user wished to obtain detailed content regarding an actor or a director, the user had to search information regarding the actor or the director on a one-by-one basis on the Internet by driving a web browser. This caused inconvenience to the user. However, according to an embodiment of the present invention, the PC 220 may search detailed content a user wishes to obtain by combining content metadata extracted from content of the kiosk 210 with user metadata, which is pre-stored in the PC 220 or input through a UI, thereby enhancing user convenience.

The service providing system 200 illustrated in FIG. 2 may also be applied when the kiosk 210 is located in a train station or a bus terminal. For example, the PC 220 combines content metadata such as departure time, arrival time, empty seats, transit point, and advance purchase with user metadata, such as a user's history, in order to generate a boarding record. Accordingly, the PC 220 or the cellular phone 230 may search detailed content that the user wishes to obtain by combining content metadata in the boarding record with user metadata, thereby enhancing user convenience.

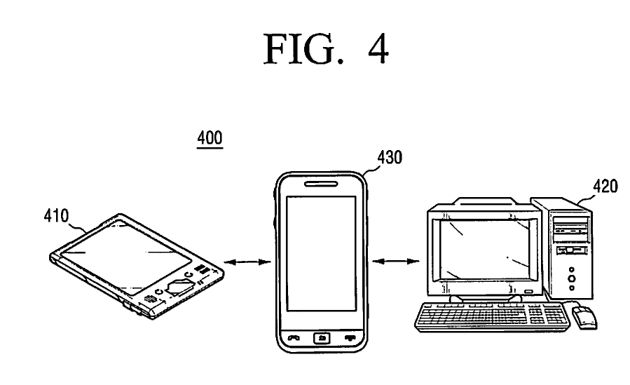

FIG. 4 illustrates a system using movie-related content provided by a content reproducing apparatus.

Referring to FIG. 4, a service providing system 400 includes a first terminal 410, a second terminal 420, and a third terminal 430. Specifically, the first terminal 410 is a content reproducing apparatus such as a PMP, the second terminal 420 is a PC, and the third terminal 430 is a cellular phone. Similarly to FIG. 2, the first terminal 410, the second terminal 420, and the third terminal 430, will be referred to as the PMP 410, the PC 420, and the cellular phone 430, respectively, for convenience of explanation. Again, the first terminal 410, the second terminal 420, and the third terminal 430 are not limited to these specific devices.

Additionally, the first terminal 410, the second terminal 420, and the third terminal 430 include the same components as illustrated in the first terminal 110, the second terminal 120, and the third terminal 130 (for example, an interface unit 131, a controller 133, a metadata extracting unit 135, a storage unit 137, a display unit 139, etc.). Accordingly, when describing the first terminal 410, the second terminal 420, and the third terminal 430, the components thereof (although not illustrated in FIG. 4) will be referred to using the same numerical identifiers illustrated in FIG. 1.

A user connects the cellular phone 430 to the PMP 410 to obtain content regarding a movie. Like the Kiosk 110 in the service providing system 200 in FIG. 2, the cellular phone 430 may be connected to the PMP 410 wirelessly or through a wired connection.

The cellular phone 430 receives content including content metadata from the PMP 410, extracts content metadata from the received content, and transmits the extracted content metadata to the PC 420.

The storage unit 137 of the cellular 430 stores the extracted content metadata such as movie title, actors/actresses, type (genre), director, producer, and DVD information, and the interface unit 121 of the PC 420 receives transmitted contents metadata.

The controller 123 of the PC 420 searches content regarding a movie by combining the received content metadata with the user metadata.

For example, if “G.I. Joe” is reproduced in the PMP 410 and user metadata is “DVD”, information regarding a part of the movie a user repeatedly watches (i.e., user metadata) may be extracted based on the number of buttons selected by the user among fast forward, fast backward, play, and stop, while the user watches a movie in the PMP 410 and the extracted information may be stored. For example, if a user repeatedly watches a fight scene, the controllers 123 and/or 133 may extract the user's preference for action movies (i.e., user metadata) and store the extracted information.

Accordingly, the controller 123 searches content regarding DVDs of action movies in which Lee, Byeong-Heon starred (i.e., related content) by combining actor Lee, Byeong-Heon, which is extracted from the content regarding “G.I. Joe” (i.e., content metadata) with user metadata indicating the user's preference for action movies. In addition, the controller 123 provides link information of searched related content.

The display unit 127 may display a DVD selling website that is linked to the related content using searched related content. Accordingly, the PC 420 provides a service for DVD sales.

Again, with reference to FIG. 4, the system using content related to a video lecture through a PMP will be explained.

For example, the content metadata extracted from the third terminal 430 may be listening, words, grammar, tense, and/or reading. If a video lecture for “Basic English” is reproduced in a the PMP 410 and user metadata is “future tense”, the PC 420 may select a movie including many future tenses from among movie scripts pre-stored in the PC 420. User metadata may be input directly, or information that a user watched a video regarding a future tense repeatedly in the past may be used.

In order to select a movie including many future tenses, it is desirable that a movie-related file provides a script, or a script is provided in the form of content metadata.

Alternatively, the PC 420 may select a movie that includes many future tenses through a searched web page. Whether to select a movie including many future tenses or a document including many future tenses may be input in advance.

Accordingly, the PC 420 may display a movie including many future tenses.

Because various types of user metadata are similar to, if not the same as, those already described above, a repetitive explanation will not be provided again.

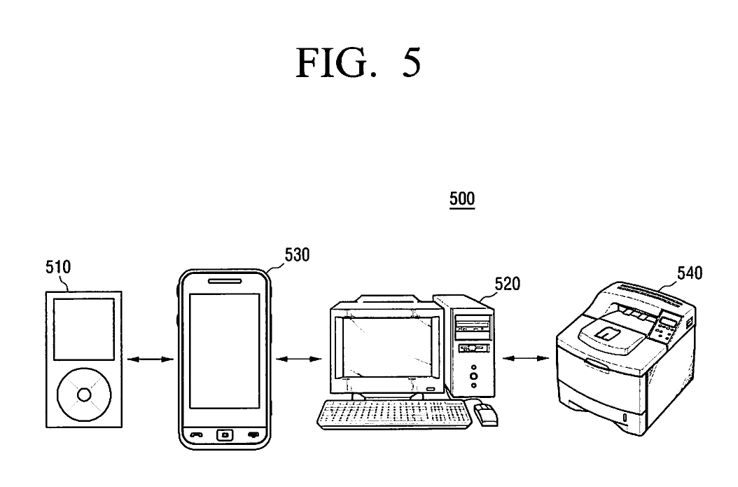

FIG. 5 illustrates a system using music-related content provided by an MP3 player.

Referring to FIG. 5, a service providing system 500 includes a first terminal 510, a second terminal 520, a third terminal 530, and a fourth terminal 540. The first terminal 510 is a content reproducing apparatus, such as an MP3 player, the second terminal 520 is a PC, the third terminal 530 is a cellular phone, and the fourth terminal 540 is an image forming apparatus, such as a printer. Hereinafter, the first terminal 510, the second terminal 520, the third terminal 530, and the fourth terminal 540 will be referred to as the MP3 player 510, the PC 520, the cellular phone 530, and the image forming apparatus 540, respectively, for convenience of explanation. However, the first terminal 510, the second terminal 520, the third terminal 530, and the fourth terminal 540 are not limited to these specific devices.

Additionally, the first terminal 510, the second terminal 520, and the third terminal 530 include the same components as illustrated in the first terminal 110, the second terminal 120, and the third terminal 130 (for example, an interface unit 131, a controller 133, a metadata extracting unit 135, a storage unit 137, a display unit 139, etc.). Accordingly, when describing the first terminal 510, the second terminal 520, and the third terminal 530, the components thereof (although not illustrated in FIG. 5) will be referred to using the same numerical identifiers illustrated in FIG. 1.

A user connects the cellular phone 530 to the MP3 player 510 to obtain content regarding some music. Like the Kiosk 110 in the service providing system 200 in FIG. 2, the cellular phone 530 may be connected to the MP3 player 510 wirelessly or through a wired connection.

The cellular phone 530 receives content including content metadata from the MP3 player 510, extracts the content metadata from the received content, and transmits the extracted content metadata to the PC 520.

The storage unit 137 of the cellular 530 stores extracted content metadata, such as such as song title, singer, featured singer, music company that the singer belongs to, and award-winning records.

The interface unit 121 of the PC 520 receives transmitted content metadata and the controller 123 of the PC 520 searches related content by combining received content metadata with user metadata.

For example, if “Heal the world” is reproduced in the MP3 player 510, the controller 123 searches content regarding a notation of “Heal the world” using content metadata extracted from content regarding “Heal the world” and information that a user frequently downloaded and previously stored a notation in the PC 520 or the cellular phone 530 (i.e., user metadata). In this case, the “notation” may be directly input as user metadata.

The display unit 127 displays a web page using a searched notation (i.e., related content).

In addition, the controller 123 transmits a command to print a notation to the image forming apparatus 540, which is connected to the PC 520 by a wire connection or wirelessly. Accordingly, the image forming apparatus 540 may output a desired notation, and thus a user may receive a corresponding service.

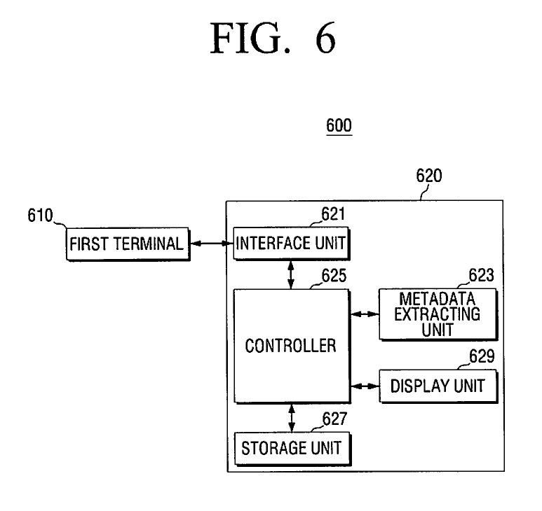

FIG. 6 illustrates a service providing system according to another embodiment of the present invention. Unlike the systems described above with reference to FIGS. 1 to FIG. 5, which include three or four terminals, the service providing system 600 includes only a first terminal 610 and a second terminal 620.

The first terminal 610 and the second terminal 620 may be connected through a wired connection or wirelessly, without connecting through a third terminal.

The first terminal 610 provides content and may be any type of content providing apparatus, such as a kiosk, a PMP, and an MP3 player.

The second terminal 620 extracts content metadata from the provided content and searches related content by combining the extracted content metadata with user metadata.

According to an embodiment of the present invention, the second terminal 620 may be a mobile apparatus, such as a cellular phone, that searches related content by downloading the related content from a web server (not shown) or a hub site (not shown). The searched related content may be displayed in a mobile apparatus.

According to another embodiment of the present invention, the second terminal 620 may be an apparatus such as a PC or a laptop computer. The PC or the laptop computer searches related content through a web server (not shown) or a hub site (not shown) and displays the searched related content therein.

The second terminal 620 includes an interface unit 621, a controller 623, a metadata extracting unit 625, a storage unit 627, and a display unit 629.

The interface unit 621 receives content metadata transmitted from the first terminal 610. The metadata extracting unit 623 extracts content metadata from provided content under the control of the controller 625, and the controller 625 searches related content by combining the extracted contents metadata with user metadata. For example, the user metadata includes a user profile, user preference, and user history. However, as described above, various embodiments may be presented depending on the type of user metadata, which is not limited to the examples above.

In the service providing system 600, a PC, which is the second terminal 620, may be connected to the first terminal. Because the metadata extracting unit 620 that extracts content metadata from content provided by the first terminal 610 is included in the second terminal 620, the service providing system 600 is distinct from the service providing systems 200, 400, and 500, as illustrated in FIGS. 2, 4, and 5, respectively. However, as all the other components operate in a similar, if not the same, way as those described above, a repetitive description will not be provided.

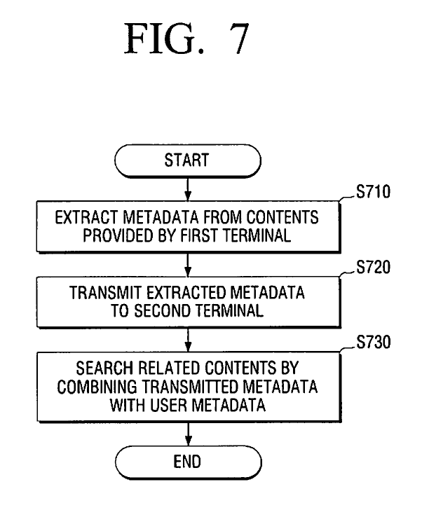

FIG. 7 is a flowchart illustrating a method for receiving content according to an embodiment of the present invention. Specifically, the method illustrated in FIG. 7 will be described with reference to the system illustrated in FIG. 1.

Referring to FIG. 7, the third terminal 130 extracts content metadata from content provided by the first terminal 110 in step S710. The third terminal 130 transmits the extracted content metadata to the second terminal 120 in step S720. In step S730, the second terminal 120 searches related content by combining the transmitted content metadata with user metadata. For example, the user metadata includes a user profile, user preference, and user history.

Accordingly, related contents may be searched by combining transmitted content metadata with user metadata, enhancing user convenience.

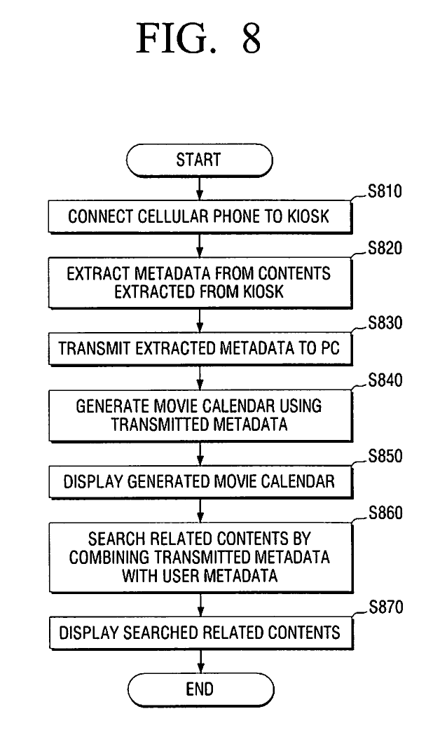

FIG. 8 is a flowchart illustrating a method for receiving content according to an embodiment of the present invention. Specifically, the method illustrated in FIG. 8 will be described with reference to the system illustrated in FIG. 2.

Referring to FIG. 8, the cellular phone 230 connects to the kiosk 210 in step S810, and extracts content metadata from content extracted from the kiosk 210 in step S820.

The extracted contents metadata is transmitted from the cellular phone 230 to the PC 220 in step S830, and the controller 123 of the PC 220 generates a movie calendar using the transmitted content metadata in step S840.

The display unit 127 of the PC 220 displays the generated movie calendar in step S850.

The controller 123 of the PC 220 searches related content by combining transmitted metadata with user metadata in step S860 and displays the searched related content in step S870.

In step S850, the display unit 127 displays a UI for designating user metadata, after displaying a movie calendar.

Alternatively, in step S850, related content may be searched automatically using pre-stored user metadata, after a movie calendar is displayed.

According to an embodiment of the present invention, a calendar may be generated and displayed using extracted content metadata, enhancing user convenience. In addition, the related content may be searched by combining transmitted content metadata with user metadata, further enhancing user convenience.

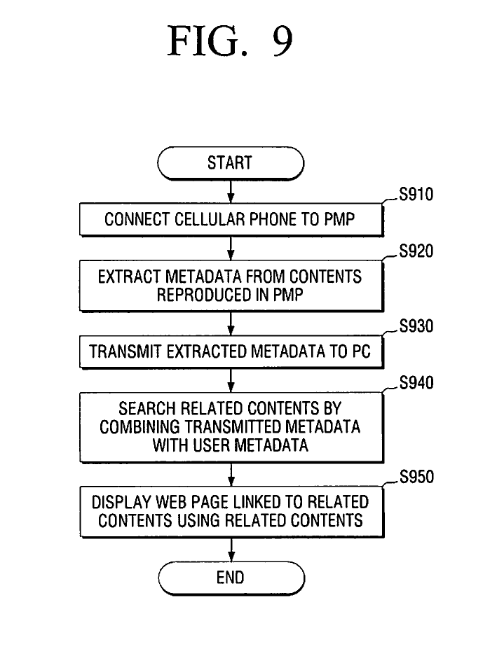

FIG. 9 is a flowchart illustrating a method for providing content according to an embodiment of the present invention. Specifically, the method illustrated in FIG. 9 will be described with reference to the system illustrated in FIG. 4.

Referring to FIG. 9, the cellular phone 430 connects to the PMP 410 in step S910 and extracts content metadata from content reproduced in the PMP 410 in step S920. In step S930, the cellular phone 430 transmits the extracted content metadata to the PC 420, and in step S940, the controller 123 of the PC 420 searches related content by combining the transmitted content metadata with user metadata.

In step S950, the display unit 127 displays a web page that is linked to the related content using the related content.

Accordingly, link information of related content is provided by combining extracted content metadata with user metadata, enhancing user convenience.

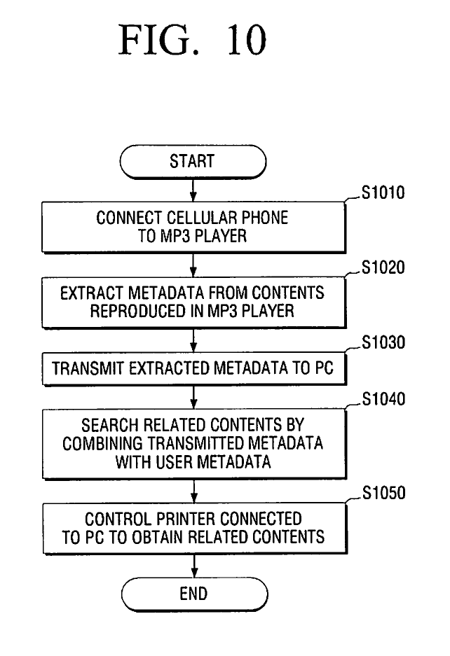

FIG. 10 is a flowchart illustrating a method for providing content according to an embodiment of the present invention. Specifically, the method illustrated in FIG. 10 will be described with reference to the system illustrated in FIG. 5.

Referring to FIG. 10, the cellular phone 530 connects to the MP3 player 510 in step S1010 and extracts content metadata from content reproduced in the MP3 player 510 in step S1020. In step S1030, the cellular phone 530 transmits the extracted content metadata to the PC 520, and in step S1040, the controller 123 of the PC 520 searches related content by combining the transmitted content metadata with user metadata.

If user metadata is something that requires printing such as “a notation”, the controller 123 of the PC 520 controls the image forming apparatus 540 by transmitting a command to print the notation to the image forming apparatus 540 connected to the PC 520 in step S1050.

Accordingly, related content is searched by combining transmitted content metadata with user metadata, and the apparatus 540 connected to the PC 520 may be controlled, enhancing user convenience.

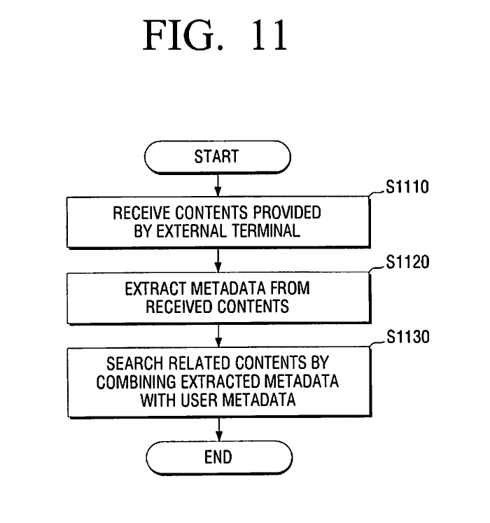

FIG. 11 is a view illustrating a method for providing content according to an embodiment of the present invention.

Referring to FIG. 11, a terminal receives content provided by an external terminal in step S1110 and extracts content metadata from the received contents in step S1120. In step S1130, related content is searched by combining the extracted content metadata with user metadata.

The content providing method illustrated in FIG. 11 may be performed by a second terminal, such as a PC, or by a third terminal, such as a cellular phone. Alternatively, the system illustrated in FIG. 6 may perform the above method.

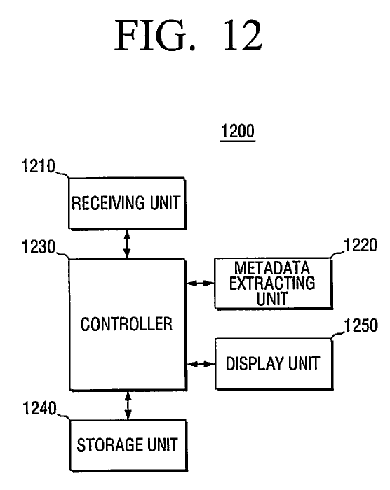

FIG. 12 illustrates a service providing apparatus according to another embodiment of the present invention.

Referring to FIG. 12, a service providing apparatus 1200 includes a receiving unit 1210, a metadata extracting unit 1220, a controller 1230, a storage unit 1240, and a display unit 1250. The service providing apparatus 1200 may be a Consumer Electronic (CE) apparatus, or other apparatus such as a television, an MP3 player, a PMP, a PDA, or a smart phone, which receives various content from an external hub site or an external server.

The receiving unit 1210 receives content and includes a communication interface (not shown) for communicating with an external apparatus. Additionally, the receiving unit 1210 receives a broadcasting signal including broadcast content, such as Electronic Program Guide (EPG) information, caption information (e.g., subtitles), and a broadcasting signal. The receiving unit 1210 may further include a component, such as a tuner, for selecting a channel.

The metadata extracting unit 1220 extracts content metadata from received content, and extracts metadata from received broadcast content. Additionally, the metadata extracting unit 1220 extracts content metadata from content being reproduced or caption information included in content being reproduced.

The controller 1230 searches related content by combining the extracted content metadata with user metadata. The user metadata may include a user profile, user preference, and user history.

The storage unit 1240 stores user metadata.

Specifically, the user metadata may be divided into user metadata regarding broadcasts such as a frequently watched channel and a registered preferred channel; user metadata regarding Internet such as a frequently visited web site address and a favorite web site address; user metadata regarding Social Network Service (SNS) such as a frequently used community service and a messenger ID registered as a friend; and user metadata regarding an external apparatus such as a frequently used printer that is connected via a Digital Living Network Alliance (DNLA) protocol, and may be stored in the storage unit 1240. In this case, the controller 1230 may automatically search related content using the stored user metadata.

The display unit 1250 displays a UI for receiving user metadata. In this case, the controller 1230 searches related content by combining the received metadata with user metadata input thorough the UI.

Accordingly, the service providing apparatus 1200 receive content from an external server or an external hub site instead of an external terminal. In particular, the service providing apparatus 1200 receives broadcast content transmitted from a broadcasting station.

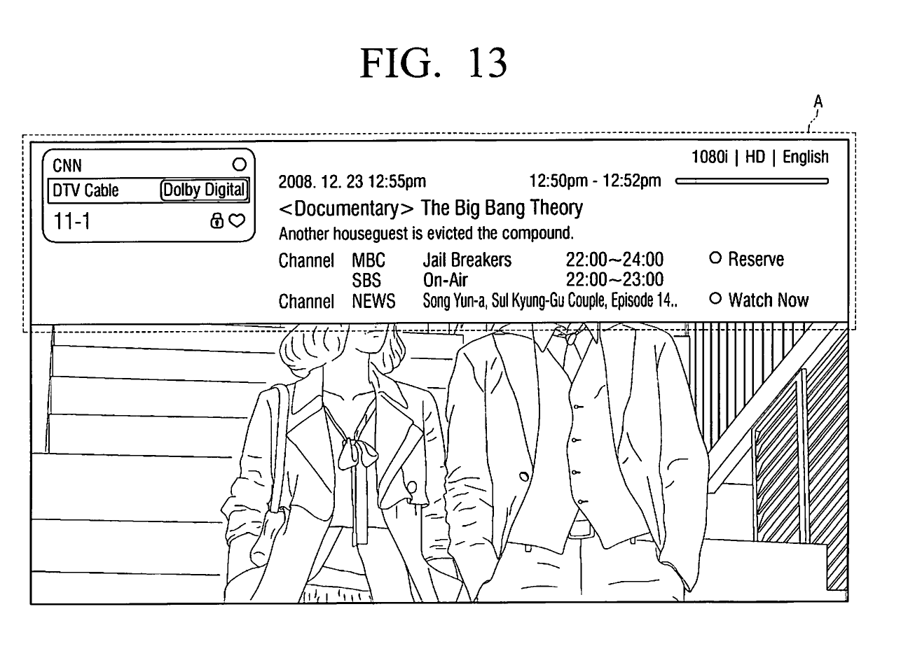

FIG. 13 illustrates a display of a display unit according to an embodiment of the present invention.

Referring to FIG. 13, the service providing apparatus 1200 is a television that receives a broadcasting signal. More specifically, the receiving unit 1210 receives a broadcasting signal, and a metadata extracting unit 1220 extracts content metadata included in the broadcast content.

For example, the metadata extracting unit 1220 extracts metadata included in EPG information transmitted with the broadcasting signal or metadata included in caption information, which is displayed on the display screen as subtitles.

Subsequently, the controller 1230 searches related content by combining the extracted metadata with user metadata pre-stored in the storage unit 1240.

As illustrated in FIG. 13, assuming that user metadata that a user's most frequently watched broadcast genre is drama, which is pre-stored in the storage unit 1240, if the user watches the drama ‘Style’ by changing a channel through a television remote controller, content regarding Internet articles about ‘Style’, the actors/actresses of ‘Style’, etc., may be displayed in an information banner area (area A) using metadata included in EPG information. In this case, content to be displayed from among related content, may be input by a user or may be pre-set.

Accordingly, unlike a conventional method where only limited content is displayed on an information banner area (area A) of a television screen, an embodiment of the present invention displays content that a user is interested in, i.e., content customized to the user on a portion of a television screen. Therefore, user convenience is enhanced.

In FIG. 13, the service providing apparatus 1200 is a television apparatus, but this is only an example, and the service providing apparatus 1200 may also be any other CE apparatus, such as an MP3 player.

As described above, the service providing apparatus illustrated in FIG. 12 includes the receiving unit 1210, the metadata extracting unit 1220, the controller 1230, the storage unit 1240, and the display unit 1250. However, according to another embodiment of the present invention, the display unit 1250 may be included in the receiving unit 1210 and the controller 1230.

In this case, the receiving unit 1210 may receive content metadata from an external terminal (not shown). In addition, the receiving unit 1210 may receive content from an external terminal (not shown).

In addition, the receiving unit 1210 receives content metadata of broadcast content provided by an external terminal. For example, the broadcast content may be caption information included in content being reproduced in an external terminal. Because operations regarding the broadcast content are similar to, if not the same as, those described above, a repetitive explanation will not be provided herein.

The controller 1230 controls the overall operation of the receiving unit 1210 and the display unit 1250. Specifically, the receiving unit 1210 receives content, and the controller 1230 extract content metadata from the received content.

In addition, the controller 1230 determines a related service based on the received content metadata and at least one user metadata and provides the determined related service. Specifically, the controller 1230 may search a related service and display a web page for providing the searched related service.

In addition, the controller 1230 determine content metadata to be used for providing a service from among the received content metadata.

For example, if an external terminal providing content metadata is a PMP and content being reproduced in the external apparatus is the movie “G.I. Joe”, the controller 1230 may determine “G.I. Joe” as content metadata to be used for providing a service from among various content metadata.

In accordance with another embodiment of the present invention, the controller 1230 determine content metadata designated by the display unit 1250 as content metadata to be used for providing a service from among various content metadata through the display unit 1250.

In accordance with another embodiment of the present invention, the controller 1230 determines content to be used for providing a service according to pre-set conditions.

In addition, the controller 1230 may determine a related service by combining determined content metadata with at least one user metadata.

In accordance with another embodiment of the present invention, the controller 1230 determines a related service by combining determined content metadata with user metadata designated by the display unit 1250.

In accordance with another embodiment of the present invention, the controller 1230 determines a related service by combining user metadata with the highest priority from among at least one user metadata with determined content metadata. The priority may be set in advance, or may be changed by a user.

In accordance with another embodiment of the present invention, the controller 1230 determines a related service by filtering at least one user metadata according to pre-set conditions and combining the filtered user metadata with determined content metadata.

In addition, the controller 1230 generates a movie calendar using content metadata provided by a kiosk and user metadata. In this case, the display unit 1250 displays the generated movie calendar.

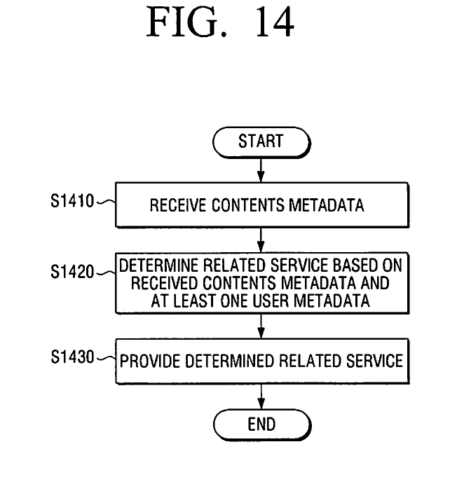

FIG. 14 is a flowchart illustrating a method for recommending a service according to an embodiment of the present invention.

Referring to FIG. 14, a terminal receives contents metadata in step S1410 and determines a related service based on the received content metadata and at least one user metadata in step S1420. In step S1430, the determined related service is provided.

A method for recommending a service suitable for a user in a service providing apparatus may further include determining content metadata to be used for providing a service from among the received content metadata.

In addition, a method for recommending a service suitable for a user in a service providing apparatus may further include displaying a UI for designating at least one user metadata.

In addition, a method for recommending a service suitable for a user in a service providing apparatus may further include generating a movie calendar using content metadata provided by a kiosk and user metadata and displaying a generated movie calendar.

Although certain embodiments of the present invention have been shown and described above, it will be appreciated by those skilled in the art that various changes may be made in these embodiments without departing from the principles and spirit of the present invention, the scope of which is defined in the claims and their equivalents.

What is claimed is:

1. A method for recommending a service in a service providing apparatus, the method comprising:
receiving content metadata;
determining a related service based on the received content metadata and a user metadata; and
providing the determined related service.

2. The method of claim 1, wherein the user metadata includes at least one of a user profile, a user preference, and a user history.

3. The method of claim 1, further comprising:
determining content metadata to be used for providing the service from among the received content metadata.

4. The method of claim 3, wherein determining the related service comprises:
combining the determined content metadata with the user metadata; and
determining the related service from a combination of the determined content metadata and the user metadata.

5. The method of claim 3, further comprising:
displaying a User Interface (UI) for designating the user metadata,
wherein determining the related service comprises:
combining the determined content metadata with user metadata designated by the UI; and
determining the related service from a combination of the determined content metadata and the user metadata designated by the UI.

6. The method of claim 1, wherein providing the determined related service comprises:
searching the related service; and
displaying a web page providing links to searched related service.

7. The method of claim 1, further comprising:
generating a movie calendar using content metadata provided by a kiosk and a user metadata; and
displaying the generated movie calendar.

8. The method of claim 1, wherein receiving the content metadata comprises:
receiving content metadata of broadcast content provided by an external terminal,
wherein the broadcast content include caption information included in content being reproduced in the external terminal.

9. A service providing apparatus, comprising:
a receiving unit that receives content metadata; and
a controller that determines a related service based on the received content metadata and a user metadata, and provides a determined related service.

10. The apparatus of claim 9, wherein the user metadata comprises at least one of:
a user profile;
a user preference; and
a user history.

11. The apparatus of claim 9, wherein the controller determines content metadata to be used for providing the service from among the received content metadata.

12. The apparatus of claim 11, wherein the controller determines the related service by combining the determined content metadata with the user metadata.

13. The apparatus of claim 11, further comprising:
a display unit that displays a User Interface (UI) for designating the user metadata,
wherein the controller determines the related service by combining the determined contents metadata with the user metadata designated by the UI.

14. The apparatus of claim 9, wherein the controller searches the related service and displays a web page that provides links to a searched related service.

15. The apparatus of claim 9, wherein the receiving unit receives content, and
wherein the controller clips the content metadata from the received content.

16. The apparatus of claim 9, wherein the controller generates a movie calendar using content metadata provided by a kiosk and user metadata, and
wherein the display unit displays the generated movie calendar.

17. The apparatus of claim 9, wherein the receiving unit receives the content metadata from broadcast content provided by an external terminal, and
wherein the broadcast content comprises caption information included in content being reproduced in the external terminal.
